(19) United States
(12) Patent Application Publication
(10) Pub. No.: US 2013/0301791 A1
(43) Pub. Date: Nov. 14, 2013

(54) PULSE ARC WELDING OF SPACER GRIDS TO GUIDE TUBES

(71) Applicant: BABCOCK & WILCOX MPOWER, INC., (US)

(72) Inventors: Andrew W. DOAN, Lynchburg, VA (US); Lewis A. WALTON, Forest, VA (US); James G. HATMAKER, Lynchburg, VA (US); George S. PABIS, Lynchburg, VA (US)

(21) Appl. No.: 13/864,168

(22) Filed: Apr. 16, 2013

Related U.S. Application Data
(60) Provisional application No. 61/625,184, filed on Apr. 17, 2012.

(51) Int. Cl. G21C 3/356; G21C 21/00; B23K 9/09

(52) U.S. Cl. CPC G21C 3/356; B23K 9/09; G21C 21/00
USPC 376/442; 219/130.51

(57) ABSTRACT

A structural skeleton of a nuclear fuel assembly is assembled by inserting guide tubes through a plurality of spacer grids, and performing pulse arc welding to connect the inserted guide tubes and the spacer grids. In the structural skeleton, the spacer grids may comprise intersecting grid straps, and at least some of the grid straps may include tabs that are pulse arc welded to guide tubes. The structural skeleton may include grid retaining rings installed on the guide tubes and pinning some spacer grids, with the grid retaining rings being pulse arc welded to guide tubes. A fuel assembly includes the structural skeleton, a plurality of fuel rods comprising fissile material passing through the spacer grids, and upper and lower end fittings secured to upper and lower ends, respectively, of the guide tubes.

This application claims priority to U.S. Provisional Application Ser. No. 61/625,184 filed on Apr. 17, 2012, which is hereby incorporated herein by reference in its entirety.

### BACKGROUND

The following relates to the nuclear reactor arts, nuclear power generation arts, nuclear reactor core construction arts, and related arts.

In nuclear reactor designs of the integral pressurized water reactor (integral PWR) type, a nuclear reactor core is immersed in primary coolant water at or near the bottom of a pressure vessel. In a typical design, the primary coolant is maintained in a subcooled liquid phase in a cylindrical pressure vessel that is mounted generally upright (that is, with its cylinder axis oriented vertically). A hollow cylindrical central riser is disposed concentrically inside the pressure vessel. Primary coolant flows upward through the reactor core where it is heated and rises through the central riser, discharges from the top of the central riser and reverses direction to flow downward back toward the reactor core through a downcomer annulus defined between the pressure vessel and the central riser. In the integral PWR design, at least one steam generator is located inside the pressure vessel, typically in the downcomer annulus. Some illustrative integral PWR designs are described in Thome et al., “Integral Helical Coil Pressurized Water Nuclear Reactor”, U.S. Pub. No. 2010/0316181 A1 published Dec. 16, 2010 which is incorporated herein by reference in its entirety. Other light water nuclear reactor designs such as PWR designs with external steam generators, boiling water reactors (BWRs) or so forth, vary the arrangement of the steam generator and other components, but usually locate the radioactive core at or near the bottom of a cylindrical pressure vessel in order to reduce the likelihood of uncovering the reactor core in a loss of coolant accident (LOCA).

In such reactors, the nuclear reactor core is built up from multiple fuel assemblies. Each fuel assembly includes a number of fuel rods. Spaced vertically along the length of the fuel assembly are spacer grids (also called grid assemblies) which hold the fuel rods with precisely defined spacings between the fuel rods. A conventional spacer grid assembly is formed by interlocking orthogonally oriented metal straps made of sheet metal to define a three-dimensional grid of square or rectangular spaces, also called grid “cells”, with each cell being delineated by four straps. Alternatively, a hexagonal arrangement can be employed in which each cell is generally hexagonal and is delineated by six straps. The straps include features, such as springs and dimples formed by cutout or deformation of the metal strip forming the strap, that protrude into the cell and engage and hold a fuel rod passing through the cell. The nuclear fuel assembly is typically terminated at top and bottom by end fittings (also called nozzles). The fuel assembly also includes guide tubes interspersed amongst the fuel rods. Control rods comprising neutron absorbing material are inserted into and lifted out of the guide tubes of the fuel assembly to control core reactivity. The guide tubes pass through designated cells of the spacer grid, which may be modified (e.g., enlarged, or formed by a merger of four adjacent cells) to accommodate the guide tubes. To form a structural skeleton for the fuel assembly, the guide tubes are welded or otherwise secured to the grid assemblies, and the upper and lower end fittings are typically secured by welding, fasteners, or the like to the upper and lower ends of the guide tubes, respectively.

In a typical approach, the guide tubes are welded to the grid assemblies using a resistance welding process. In resistance welding, two or more metal parts to be welded together are clamped together. Electrodes are placed on the metal parts to pass current through the parts. This generates heat, resulting in a melting together of the contacting surfaces of the metal parts. The metal parts can generally be in any shape, so long as there is a common surface upon which they can be clamped together. In some resistance welding approaches, the clamping pressure is a component of the weld formation. The resistance welding process for welding a guide tube to a grid spacer assembly generally utilizes a chill block/electrode on a long rod inserted in the guide tube to the weld region to prevent distortion of the guide tube.

In another approach, which does not entail welding, guide tubes are connected to the grid assemblies via swaging. Swaging is a process by which two loosely fitting parts are joined together by using a mechanical or hydraulic tool to compress and deform the two parts together, creating a permanent joint. As applied to the present task, bulged (i.e. swaged) features are formed in the guide tube above and below the grid to secure the guide tube in place. To form the bulges, specialized tooling on long extensions is positioned precisely inside the guide tube and expanded to form the bulges. Both the tooling and features are designed to minimize the stress and potential cracking in the formed region.

### BRIEF DESCRIPTION

In accordance with one aspect, a method comprises assembling a structural skeleton of a nuclear fuel assembly by operations including: inserting guide tubes through a plurality of spacer grids; and performing pulse arc welding to connect the inserted guide tubes and the spacer grids.

In accordance with another aspect, a fuel assembly includes a bundle of fuel rods arranged mutually in parallel wherein the fuel rods include fissile material, a plurality of guide tubes arranged in parallel with and interspersed amongst the fuel rods, an upper end fitting connected with upper ends of the guide tubes, a lower end fitting connected with lower ends of the guide tubes, and a plurality of spacer grids comprising intersecting grid straps. The spacer grids are disposed between the upper end fitting and the lower end fitting and are spaced apart along the bundle of fuel rods. The grid straps of at least some of the spacer grids include tabs extending away from the grid straps that are welded to the guide tubes. In some embodiments, the tabs extending away from the grid straps of at least some of the spacer grids are pulse arc welded to the guide tubes by pulse arc welds.

In accordance with another aspect, a structural skeleton of a nuclear fuel assembly includes a plurality of guide tubes arranged mutually in parallel, a plurality of spacer grids comprising intersecting grid straps, the guide tubes passing through the spacer grids, and pulse arc welds securing the spacer grids to the guide tubes. At least some of the pulse arc welds may be between grid straps of spacer grids and guide tubes. The structural skeleton may further include grid retaining rings installed on the guide tubes and pinning at least some of the spacer grids, wherein at least some of the pulse arc welds that secure the spacer grids to the guide tubes are between the grid retaining rings and guide tubes.

In accordance with another aspect, a nuclear fuel assembly includes a structural skeleton as set forth in the immediately preceding paragraph, fuel rods comprising fissile material passing through the spacer grids, and end fittings secured to the upper and lower ends of the guide tubes.

### BRIEF DESCRIPTION OF THE DRAWINGS

FIG. 1 shows a diagrammatic partial cutaway view of an illustrative nuclear fuel assembly including a structural skeleton comprising spacer grids and guide tubes welded together using a diagrammatically shown pulse arc welding system.

FIG. 2 diagrammatically shows a side view of an illustrative spacer grid strap including tabs to provide locations for pulse arc welding to a guide tube.

FIG. 3 diagrammatically shows an end view of the spacer grid strap of FIG. 2.

FIG. 4 diagrammatically shows a side view of an illustrative spacer grid strap with hemispherical tabs welded to a guide tube using pulse arc welding.

FIG. 5 diagrammatically shows a side view of a portion of a guide tube with a pair of retainer rings that are pulse arc welded to a guide tube to secure the guide tube to a spacer grid.

FIG. 6 diagrammatically shows an illustrative layout for guide tubes in a spacer grid, showing a preferred “inside-out” welding order.

FIG. 7 shows a process flow chart for welding the guide tubes to the spacer grids.

### DETAILED DESCRIPTION

It is recognized herein that the conventional approach of resistance welding guide tubes to spacer grids has substantial disadvantages. One disadvantage is that the weld can “punch through” the guide tube so as to distort or damage the inside surface of the guide tube. Such distortion or damage can interfere with movement of the control rod (or other element, e.g. in-core instrumentation assembly) through the guide tube. Since rapid insertion of control rods into the reactor core (i.e., SCRAM) is a safety-critical operation, any interference with control rod motion inside the guide tube is problematic.

Another disadvantage of conventional resistance welding of the guide tube with the spacer grid is difficulty in post-weld assessment and verification. A distorted surface or “crater” is sometimes observed at the weld site. However, the existence of the crater does not ensure the grid material actually bonded to the guide tube. The bond region is sandwiched between the grid and tube so it is not visible for inspection. Moreover, it is generally advisable to employ a fiber-optical scope or other inspection apparatus to ensure that the resistance weld has not distorted or damaged the inside surface of the guide tube.

Another disadvantage of conventional resistance welding is that the outside of the guide tube must be accessible to a pinch clamp electrode and the inside of the guide tube must be accessible in order to insert the chill block/electrode into the guide tube at the location of the weld. A dashpot is often located at the bottom end of each guide tube to cushion stoppage of the control rod during scram. This dashpot can interfere with insertion of the chill block/electrode, or alternatively the manufacturing process may be modified to install the dashpot after the guide tube is welded to the spacer grids. The chill block/electrode can also introduce debris or contaminants inside the guide tube, which again may interfere with motion of the control rod.

Similar problems are recognized herein when using swaging. Again, an element (the swaging instrument) must be inserted inside the tube, and the swaging of the guide tube to create the bulge can introduce damage or distortion to the inner surface of the guide tube.

It is disclosed herein to employ pulse arc welding to weld the guide tubes to the spacer grids. This approach has substantial advantages over the conventional techniques of resistance welding and swaging. Pulse arc welding does not require access to the inside of the guide tube. Moreover, the amount of energy applied in any single weld operation is precisely controlled, with each electrical pulse having a fixed energy (e.g., suitably specified in watt-seconds or joules). By setting this pulse energy sufficiently low, it can be assured that the weld cannot punch through the guide tube and will not heat the inside surface of the guide tube to an unacceptably high temperature. (Said another way, the heat-affected zone of the pulse arc weld operation can be designed to ensure that it does not extend to the inside surface of the guide tube). Indeed, pulse arc welding provides a less penetrating heat-affected zone even as compared with other “surface” welding techniques such as laser welding or electron beam welding. (Additionally, electron beam welding must be performed in vacuum, and laser welding typically produces sufficiently high temperatures to favor employing an evacuated or inert gas-backfilled welding chamber).

On the other hand, multiple pulses can be applied sequentially (with suitable delay to dissipate energy between the pulses) in order to provide enough weld points to secure the guide tube to the spacer grid. Still further, pulse arc welding of materials typically used in guide tubes and spacer grids, e.g. Inconel or Zircaloy, can be welded without using filler metal, so that the pulse arc welding does not introduce foreign material to the nuclear reactor environment. The resulting weld points are also externally visible to enable visual inspection (optionally using machine vision). Still further, the rapidity of the pulse arc welding operation enables it to be performed in an air ambient (optionally employing a shielding or cover gas such as argon to suppress oxidation at the weld).

One disadvantage of pulse arc welding is that the weld points must be externally accessible to the welding torch of the pulse arc welding system. By contrast, techniques such as resistance welding or swaging do not require external access to the weld point. As disclosed herein, this can be remedied by performing the welding “inside-out” starting with welding of the innermost guide tubes in the fuel assembly and working outward to the peripheral guide tubes of the fuel assembly. Moreover, because a given guide tube may be welded to each spacer grid using multiple pulse arc weld operations forming several weld points, it is recognized that some of these weld points can be omitted for a given guide tube for one or more of the spacer grids while still retaining acceptable structural skeleton strength for the fuel assembly.

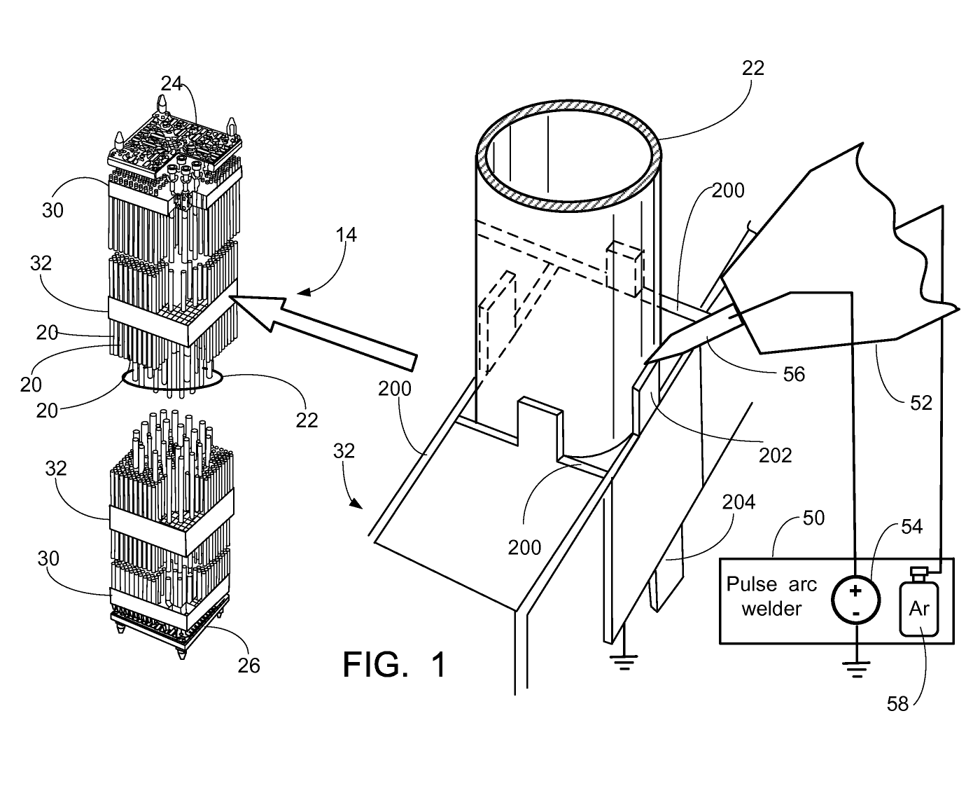

With reference to FIG. 1, a representative fuel assembly 14 is diagrammatically shown with partial breakaway and the front top corner of the perspective view cut away to reveal internal components. The fuel assembly 14 is suitably employed as an element of a nuclear reactor core disposed in a pressure vessel. For example, one contemplated reactor core design comprises sixty-nine fuel assemblies substantially similar to the illustrative fuel assembly 14, arranged in a generally rectangular pattern with some “smoothing” of the corners. The fuel assembly 14 includes an array of vertically oriented fuel rods 20 each comprising a fissile material such as ²³⁵U. For example, each fuel rod may contain enriched uranium dioxide (UO₂) or mixed UO₂/gadolinium oxide (UO₂—Gd₂O₃) pellets. Interspersed amongst the fuel rods 20 are guide tubes 22 that provide conduits for control rods, in-core instrumentation assemblies, or so forth. The top of the fuel assembly 14 is terminated by an upper end fitting or nozzle 24 that is connected with upper ends of the guide tubes 22 by threaded fasteners, welding, or the like, and the bottom of the fuel assembly 14 is terminated by a lower end fitting or nozzle 26 that is connected with lower ends of the guide tubes 22 by threaded fasteners, welding, or the like.

The fuel assembly 14 is held together by a plurality of spacer grids including end grids 30 disposed at the top and bottom of the fuel assembly 14 and one or (typically) more mid-grids 32 disposed at spaced apart positions between the top and bottom of the fuel assembly 14. (Said another way, each end spacer grid 30 is closer to an end of the bundle of fuel rods 20 than the mid-grid 32). Illustrative FIG. 1 shows only two mid-grids 32, but typically additional mid-grids are present which are omitted in the cutaway illustration. The number of mid-grids, and the spacing of the end grids and mid grids along the height of the fuel assembly, is determined based on the total length of the bundle of fuel rods, the total number of fuel rods in the bundle, the structural characteristics of the fuel rods, applicable regulatory requirements, and so forth.

With continuing reference to FIG. 1, the guide tubes are welded to the spacer grids using pulse arc welding. The right-side of FIG. 1 shows a single guide tube 22 passing through a portion of a mid-grid 32. The right-hand side shows a point during construction of the fuel assembly that is after construction of the mid-grid 32 but before installation of the fuel rods 20. As shown, the mid-grid 32 is constructed of a plurality of straps 200 that intersect at generally right angles defining a grid structure. The grid structure has a plurality of openings or cells defined by the intersecting straps 200. The guide tube 22 is illustrated passing through one of said openings generally defined by two sets of parallel intersecting grid straps 200. The grid straps 200 are modified at the cell receiving the guide tube 22 to include upper weld tabs 202 and lower weld tabs 204 for welding to the guide tube 22 using pulse arc welding. Optionally, additional modifications may be present at the cell receiving the guide tube 22, such as the cell being enlarged or distorted compared with cells that receive fuel rods. Such additional modifications may be appropriate if, for example, the guide tubes 22 are of larger diameter than the fuel rods 20.

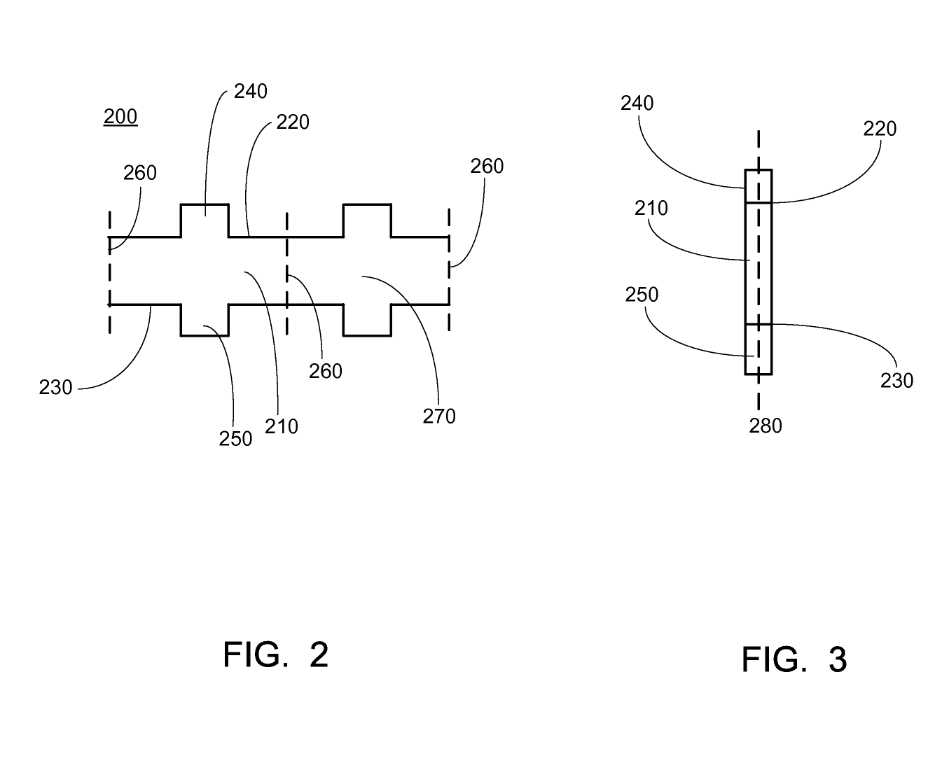

With brief reference to FIGS. 2 and 3, and initially FIG. 2, a single grid strap 200 is shown in isolation. The grid strap 200 includes a body 210 that defines a first edge (or top edge) 220 and a second edge (or bottom edge) 230. A first weld tab 240 (e.g., upper weld tab 202) extends from the body 210 beyond the first edge 220, i.e away from the body. A second weld tab 250 (e.g., lower weld tab 204) extends from the body beyond the second edge 230, i.e away from the body. Dotted lines 260 are present on FIG. 2 to indicate where the grid strap 200 interlocks with other grid straps (not shown) to form a cell 270. As seen in FIG. 3, the body 210, first weld tab 240, and second weld tab 250 are in a common plane 280. It will be appreciated that each grid assembly is comprised of a plurality of parallel and spaced apart grid straps extending in a first direction that are mated with and secured to a plurality of parallel and spaced apart grid straps extending in a second direction orthogonal to the first direction. In an alternative embodiment, the grid assemblies can be machined from a solid piece of material.

With returning reference to FIG. 1, a pulse arc welding system includes a pulse arc welder 50 and a welding torch 52. The pulse arc welder 50 includes a power supply 54 designed to deliver an electrical pulse of user-selectable energy (suitably measured, for example, in watt-seconds or joules) to an electrode 56 of the welding torch 52. The pulse arc welder may also permit user control of other aspects such as the electrical pulse shape (e.g., ramp-up, ramp-down, dwell time, et cetera, or in embodiments employing a pulse comprising a dense packet of sub-pulses, parameters of the packet envelope), maximum voltage and/or current settings, or so forth. The pulse arc welder 50 optionally further includes or operatively controls a shielding or cover gas, such as an illustrative argon gas 58, which is flowed by the welding torch 52 over the electrode 56 during a pulse arc welding operation to suppress oxidation during the welding operation. The pulse arc welding can be performed manually or using a robotic apparatus. The pulse arc welding can be performed in air, that is, without employing a welding chamber with a controlled atmosphere (although as already noted, an inert shielding or cover gas is optionally employed to suppress oxidation during the welding). Not using a welding chamber is advantageous since the guide tubes can have lengths of several meters. The electrode 56 is suitably a tungsten electrode, although an electrode of another electrode material is also contemplated. A filler metal is typically not employed; rather, the weld is formed by joining of the metal of the tabs 202, 204 with the outer surface of the guide tube 22. Alternatively, a filler metal may be used.

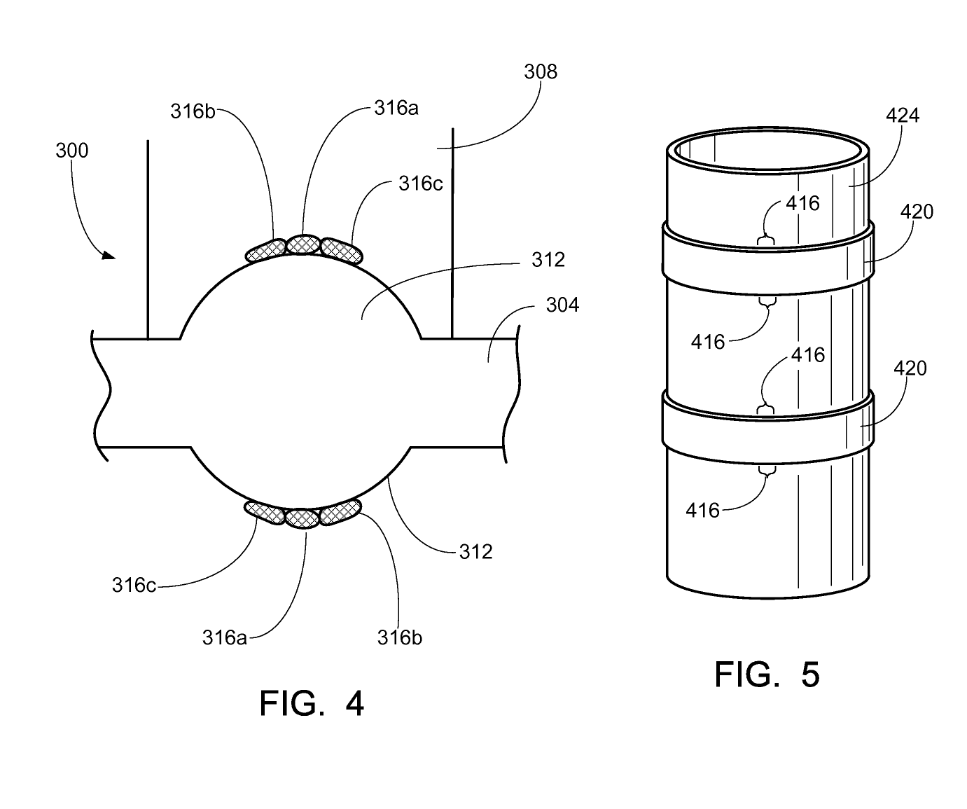

FIG. 4 diagrammatically shows an illustrative pulse arc weld of a mid-grid-to-guide tube joint 300. Weld tabs 312 extend from a grid strap 304 above and below each guide tube cell to make the interface between the grid strap 304 and a guide tube 308 more accessible for welding. In FIG. 5, a single pair of weld tabs 312 is shown, but it will be appreciated that there can be upper and lower weld tabs on each of the four grid straps surrounding a given guide tube 308. In addition, the weld tabs 312 have a rounded shape as opposed to the generally rectangular shape weld tabs shown in previously figures. It should be appreciated, therefore, that the first edge and the second edge of the grid strap do not need to be straight or planar edges, such that weld tabs of different shapes are contemplated. Moreover, in some embodiments the tabs 202, 204 or tabs 312 are omitted entirely, and the weld to the guide tube is made at the upper and lower edges of the strap.

In FIG. 4, three pulse arc welds 316a, 316b and 316c are illustrated. In one approach, the center weld 316a is first created in a first pulse weld operation (that is, with a first electrical pulse), and then the side welds 316b and 316c are created. The welds could be created in a different order and/or a fewer or greater number of welds can be created depending on a given application. Moreover, some tabs may not be welded, for example if they are not accessible to the welding torch 52. The pulse arc welds securely bond the weld tab 312 to the guide tube 308 without inserting tooling inside the guide tube. The welds are also externally visible for inspection as they are located at the edge of the weld tab 312. The energy of the pulse arc weld operation is selected to avoid causing damage or distortion on the inside of the guide tube 308. This selection can be done based on simulation of the heat-affected zone and/or by empirical calibration by performing pulse arc weld operations on a test guide tube and inspecting the inside of the tube to determine the optimal pulse energy. In addition to the pulse energy, other parameters such as maximum voltage and/or maximum current, pulse shape, or so forth may be controlled to optimize the pulse weld operation.

The welds shown in FIGS. 1 and 4 directly weld the spacer grid to the guide tube. This approach is well suited to situations in which the spacer grid and the guide tube are made of the same material, as welding without filler metal is typically most effective between items of the same material. In some contemplated nuclear fuel assemblies, the guide tubes 22 are made of a Zircaloy, the mid-grids 32 (see FIG. 1) are made of a Zircaloy, and the end-grids 30 are made of Inconel. (This choice of material is motivated by the lower neutron absorption characteristics of Zircaloy compared with Inconel and by the preferable mechanical properties of Inconel as compared with Zircaloy). In constructing such a nuclear fuel assembly, the mid-grids 32 are made of a similar or same material as the guide tubes 22, and so the direct grid-to-tube weld of FIGS. 1 and 4 are suitable for these welds. On the other hand, in such a nuclear fuel assembly the Inconel end-grids 30 are made of a dissimilar material as compared with the Zircaloy guide tubes 22.

With reference to FIG. 5, a suitable approach for attaching Inconel end-grids with Zircaloy guide tubes is shown. In this approach, pulse arc welds 416 secure first and second axially-spaced apart end grid-retaining rings 420, so as to pin the end-grid 30 between the retaining rings 420. The retaining rings 420 are suitably made of Zircaloy so that the pulse arc welds 416 join Zircaloy-to-Zircaloy. The end grid retaining rings 420 are secured to the guide tube 424 with a end-grid strap in-between to secure the end grid 4## to the guide tube 424.

The disclosed approach of employing pulse arc welding to secure the spacer grids to the guide tubes generally eliminates the need for long tooling to be positioned inside the guide tube during welding operations. In addition, much more accurate application of energy to the welding site through a pulse arc process reduces or eliminates damage to the interior of the guide tubes that may occur when other methods are employed, such as resistance welding techniques. In addition, the pulse arc welds are externally accessible and visible for inspections. Also, the bottom end grid and the lowest mid grid can be secured using pulse arc welds directly to the guide tube despite the presence of the tube-in-tube dashpot on the inside.

During fuel assembly loading and unloading operations in the reactor core, the grids may be subjected to vertical loads. For example, an edge of a grid may be caught on a grid of a neighboring fuel assembly. In addition, a slip load is generated as the fuel rods are loaded/unloaded. The weld joints should be strong enough to survive the normal operational loads. In one example, eight weld joints secure a grid to one of the twenty-four guide tubes. In a second example more or less than eight weld joints secure the grid.

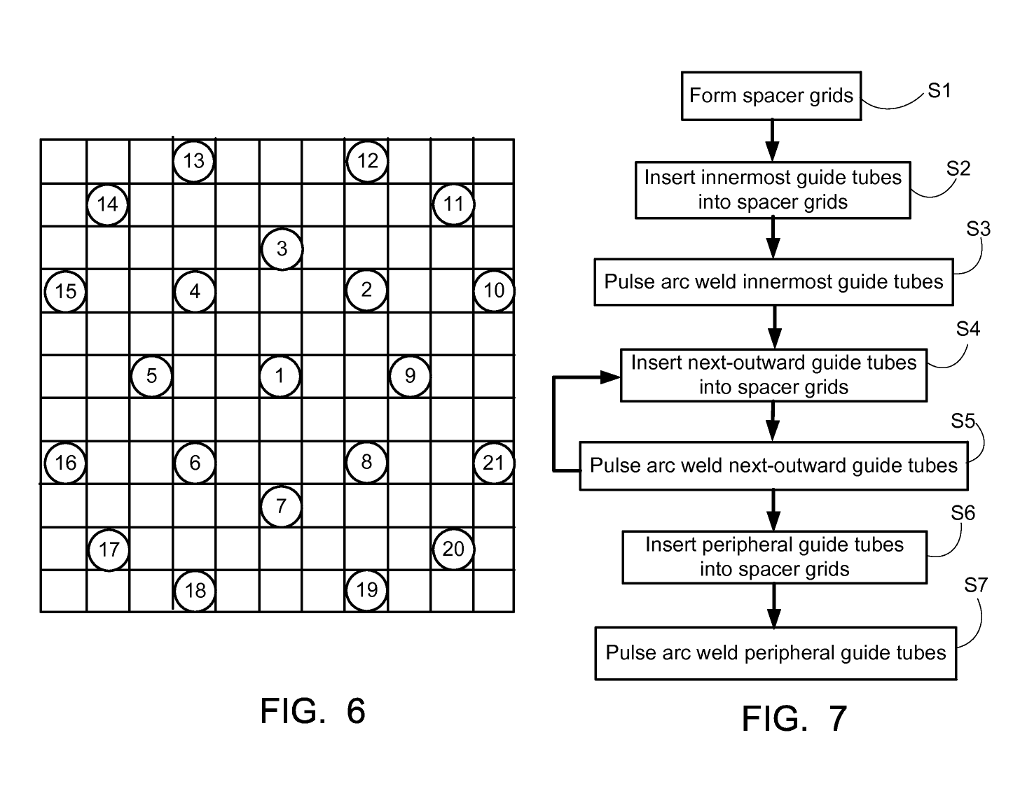

With reference to FIGS. 6 and 7, a suitable construction process is described. FIG. 6 shows a plan view of a spacer grid with the locations of guide tubes indicated by numbered circles, where the inscribed number (running from 1 to 21 in FIG. 6) indicates the welding order. FIG. 7 shows a process flow chart. In an operation S1, the spacer grids are formed, for example by forming the straps by stamping, machining, or other suitable processing to define the dimples, springs, and interlocking slots and then interleaving and welding together the straps to form the grid. In an operation S2, the innermost guide tubes are inserted into the spacer grids. In this operation each innermost guide tube is inserted through all the spacer grids (e.g., both end grids 30 and all the mid-grids 32 in the example of FIG. 1). In illustrative FIG. 6, there is only one innermost guide tube, enumerated “1”. In an operation S3, the innermost guide tubes are pulse arc welded to the grids—that is, to all the spacer grids, e.g. all end- and mid-spacer grids 30, 32 in illustrative FIG. 1. This process is iteratively repeated in operations S4, S5 to insert and weld each next-outward set of guide tubes. In illustrative FIG. 6, this entails welding guide tubes enumerated “2” through “9”. The process is complete when, in operations S6 and S7 the peripheral guide tubes are inserted and welded.

By working “inside-out” as described with reference to FIGS. 6 and 7, the issue of welding torch access to the welds is mitigated. In contrast, if all guide tubes are inserted before any welding begins, welding torch access to the inner guide tubes may be blocked by more peripheral guide tubes. Additionally, it is recognized herein that some welds may be omitted while maintaining sufficient structural strength for the nuclear fuel assembly.

The operations S1-S7 of FIG. 7 form the structural skeleton of the nuclear fuel assembly 14. In further operations (not listed in FIG. 7), the fuel rods 20 comprising fissile material are inserted through the spacer grids so that they are held by the features (e.g., springs and dimples) of the cells of the spacer grids, and the upper and lower end fittings 24, 26 are secured to the upper and lower ends, respectively, of the guide tubes. The resulting fuel assembly is then loaded into a nuclear reactor in accord with a nuclear reactor core layout.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

We claim:

1. A method comprising:
assembling a structural skeleton of a nuclear fuel assembly by operations including:
inserting guide tubes through a plurality of spacer grids; and
performing pulse arc welding to connect the inserted guide tubes and the spacer grids.

2. The method of claim 1 wherein the performing of pulse arc welding comprises:
performing pulse arc welding operations each employing a pulse arc having energy low enough that the heat-affected zone of the pulse arc weld operation does not extend to the inside surface of the guide tube.

3. The method of claim 1 wherein the inserting and the performing comprises:
(i) inserting innermost guide tubes through the plurality of spacer grids and performing pulse arc welding to connect the inserted innermost guide tubes and the spacer grids; and
(ii) after operation (i) is completed, inserting peripheral guide tubes through the plurality of spacer grids and performing pulse arc welding to connect the inserted peripheral guide tubes and the spacer grids.

4. The method of claim 1 further comprising:
installing grid retaining rings on the guide tubes with at least one spacer grid of the plurality of spacer grids pinned between installed grid retaining rings;
wherein the performing of pulse arc welding includes performing pulse arc welding to connect the inserted guide tubes and the installed grid retaining rings wherein the at least one spacer grid that is pinned between the installed grid retaining rings is connected with the guide tube.

5. The method of claim 4 wherein the performing of pulse arc welding further includes performing pulse arc welding to weld together the inserted guide tubes and spacer grids of the plurality of spacer grids other than the at least one spacer grid that is pinned between the installed grid retaining rings.

6. The method of claim 5 wherein:
the guide tubes are Zircaloy guide tubes;
the at least one spacer grid that is pinned between the installed grid retaining rings are two Inconel end-grids; and
the spacer grids of the plurality of spacer grids other than the two Inconel end-grids are Zircaloy mid-grids.

7. The method of claim 1 wherein the performing of pulse arc welding includes performing pulse arc welding to weld together the inserted guide tubes and spacer grids of the plurality of spacer grids.

8. The method of claim 7 wherein the performing of pulse arc welding to weld together the inserted guide tubes and spacer grids of the plurality of spacer grids comprises:
performing pulse arc welding operations to weld together the inserted guide tubes and tabs extending from straps of the spacer grids.

9. The method of claim 1 further comprising:
after assembling a structural skeleton of a nuclear fuel assembly, completing assembly of the nuclear fuel assembly by operations including at least inserting fuel rods comprising fissile material through the spacer grids and securing upper and lower end fittings to the upper and lower ends respectively of the guide tubes.

10. The method of claim 9 further comprising:
after completing assembly of the nuclear fuel assembly, installing the nuclear fuel assembly in a nuclear reactor.

11. An apparatus comprising:
a fuel assembly including:
a bundle of fuel rods arranged mutually in parallel wherein the fuel rods include fissile material;
a plurality of guide tubes arranged in parallel with and interspersed amongst the fuel rods;
an upper end fitting connected with upper ends of the guide tubes;
a lower end fitting connected with lower ends of the guide tubes; and
a plurality of spacer grids comprising intersecting grid straps, the spacer grids disposed between the upper end fitting and the lower end fitting and spaced apart along the bundle of fuel rods;
wherein the grid straps of at least some of the spacer grids include tabs extending away from the grid straps that are welded to the guide tubes.

12. The apparatus of claim 11 wherein the tabs extending away from the grid straps of at least some of the spacer grids are pulse arc welded to the guide tubes by pulse arc welds.

13. The apparatus of claim 12 wherein at least some tabs are pulse arc welded to the guide tubes by two or more pulse arc welds per tab.

14. The apparatus of claim 11 wherein the plurality of spacer grids include two end-grids and a plurality of mid-grids disposed between the two end grids, the mid-grids being the spacer grids that include tabs extending away from the grid straps, the end grids not including tabs extending away from the grid straps.

15. The apparatus of claim 14, wherein the end-grids are pinned between grid retaining rings installed on the guide tubes, the grid retaining rings being welded to the guide tubes.

16. The apparatus of claim 15 wherein:
the tabs extending away from the grid straps of the mid-grids are pulse arc welded to the guide tubes by pulse arc welds; and
the grid retaining rings are welded to the guide tubes by pulse arc welds.

17. The apparatus of claim 15 wherein:
the guide tubes are Zircaloy guide tubes;
the mid-grids are Zircaloy mid-grids; and
the end-grids are made of a material other than Zircaloy.

18. An apparatus comprising:
a structural skeleton of a nuclear fuel assembly, the structural skeleton including:
a plurality of guide tubes arranged mutually in parallel;
a plurality of spacer grids comprising intersecting grid straps, the guide tubes passing through the spacer grids; and
pulse arc welds securing the spacer grids to the guide tubes.

19. The apparatus of claim 18 wherein at least some of the pulse arc welds are between grid straps of spacer grids and guide tubes.

20. The apparatus of claim 19 wherein the pulse arc welds between grid straps of spacer grids and guide tubes are between tabs of the grid straps and guide tubes.

21. The apparatus of claim 18 wherein the structural skeleton further includes:
grid retaining rings installed on the guide tubes and pinning at least some of the spacer grids, wherein at least some of the pulse arc welds that secure the spacer grids to the guide tubes are between the grid retaining rings and guide tubes.

22. The apparatus of claim 18 wherein the plurality of spacer grids include two end grids and a plurality of mid-grids disposed between the end-grid, and the structural skeleton further includes:
grid retaining rings installed on the guide tubes and pinning the end-grids, the pulse arc welds including
(i) pulse arc welds between grid straps of the mid-grids and guide tubes, and
(ii) pulse arc welds between the grid retaining rings and guide tubes,
there being no pulse arc welds between grid straps of the end-grids and guide tubes.

23. The apparatus of claim 22 wherein:
the guide tubes are Zircaloy guide tubes;
the mid-grids are Zircaloy mid-grids; and
the end-grids are made of a material other than Zircaloy.

24. The apparatus of claim 18 further comprising:
a nuclear fuel assembly including said structural skeleton, fuel rods comprising fissile material passing through the spacer grids, and end fittings secured to the upper and lower ends of the guide tubes.
